(19) United States
(12) Patent Application Publication
(10) Pub. No.: US 2026/0265579 A1
(43) Pub. Date: Sep. 10, 2026

(54) THERMOPLASTIC ADHESIVE TAPE WITH TAILORED DEFECTS FOR IMPROVED STRENGTH AND TOUGHNESS AND THEIR PROCESSING METHOD

(71) Applicant: KING ABDULLAH UNIVERSITY OF SCIENCE AND TECHNOLOGY, Thuwal (SA)

(72) Inventors: Gilles LUBINEAU, Thuwal (SA); Hassan MAHMOUD, Thuwal (SA); Ran TAO, Thuwal (SA); Ahmed WAGIH, Thuwal (SA)

(21) Appl. No.: 19/106,318

(22) PCT Filed: Apr. 13, 2023
(86) PCT No.: PCT/IB2023/053799

§ 371 Date: Feb. 25, 2025

Related U.S. Application Data
(60) Provisional application No. 63/402,143, filed on Aug. 30, 2022.

(51) Int. Cl. C09J 7/20; C09J 5/00

(52) U.S. Cl. CPC C09J 7/203; C09J 5/00; C09J 2301/124; C09J 2301/162; C09J 2301/204; C09J 2400/22; C09J 2467/00

(57) ABSTRACT

A double-sided tape includes a carrier layer having first and second sides opposed to each other, a first adhesive layer located on the first side of the carrier layer, a second adhesive layer located on the second side of the carrier layer, and first defects located between the first side of the carrier layer and the first adhesive layer, or fully within the carrier, or fully within the first adhesive layer. The carrier layer is flexible.

### CROSS-REFERENCE TO RELATED APPLICATIONS

This application claims priority to U.S. Provisional Patent Application No. 63/402,143, filed on Aug. 30, 2022, entitled “TOUGHENING THERMOPLASTIC ADHESIVE TAPES USING TAILORED DEFECTS,” the disclosure of which is incorporated herein by reference in its entirety.

### BACKGROUND OF THE INVENTION

### Technical Field

Embodiments of the subject matter disclosed herein generally relate to a pressure sensitive thermoplastic adhesive tape and method for making the tape, and more particularly, to a tape that includes plural defects strategically distributed within the tape to enhance its toughness and strength.

### Discussion of the Background

Adhesive bonding is one of the most common techniques used to join together primary and secondary structures. It is currently applied in primary structures such as aircraft wings and body panel stiffeners, and assembly of automobile parts. Moreover, it is used in the assembly and insulation of modern civil engineering structures for many purposes. Additionally, it is widely used in medical applications such as wound dressing, electrode-attachment in electrocardiogram tests and transdermal drug delivery system. Many classifications for the adhesives are available in the literature, depending on their origin material (natural, synthetic), curing process (physical, chemical), use (structural, non-structural), and matrix type (thermoset or thermoplastic), which is the most common classification.

The thermoset adhesives are usually applied to structural applications and usually are cured using chemical or mixed chemical and physical processes.

The bonding process includes adherends surface preparation, applying of the adhesive, bonding the two adherends, and applying pressure and curing for relatively long periods. Once they are cured, the two adherends are difficult to separate. This class of adhesives has received a lot of attention due to its deep application in aerospace and aircraft structures. Many attempts have been made to improve the structural integrity and toughness of the thermoset-based adhesive joints including interleaving, fiber stitching, Z-pinning, and treatment of the substrates.

Particularly, a research group associated with the inventors of this application has a significant contribution to this track. The inventors developed three novel techniques to improve the toughness and structural integrity for thermoset-based adhesive joints. The first technique modifies the microstructure of the adherends using laser-based heterogeneous surface treatments. In this technique, the inventors demonstrated that creating an alternative pattern of high-and low-power laser treatment on the adherend surfaces could improve the most common failure modes (mode I and II toughness) reaching 3 and 2 times, respectively, compared to untreated joints. The toughness improvement in this case was due to the activation of nonlocal damage mechanisms that dissipate extra energy during loading. The damage mechanisms include the generation of secondary cracks, and the adhesive ligament formation and breakage. Moreover, applying this technique to structural T-joint resulted in an improvement of 2 and 15 times in the strength and toughness of the joint, respectively, compared to the untreated T-joints. The second technique involved toughening the thermoset adhesive bond line using thermoplastic carriers. The employment of this technique for adhesive joints results in an improvement of 350% compared to the pure thermoset-adhesive joint due to the high plasticity of the thermoplastic carrier that dissipates large energy during deformation. The third method is related to mimicking biological adhesion systems such as gecko and mylituscalifornianus in the adhesive bonding by introducing sacrificial cracks inside the bond line, that mimics the voids in the biological adhesion systems [1]. This technique results in an improvement of the mode I and II toughness by 150% and 200%, respectively, compared to the conventional joints.

On the other hand, the thermoplastic adhesive tapes can be used for fast bonding, where the joint does not require a long curing time or specific curing conditions, which makes them very suitable for construction and medical applications. For construction purposes, the tapes were used for sealing diffusion film joints with roof elements and concrete floors with masonry blocks. Moreover, they were used to ensure building air-tightness at doors and windows, which prevents the air from entering in air conditioned buildings that plays a major role in the energy efficiency of state-of-the art buildings. For medical purposes, these adhesive tapes were widely used in the manufacturing of human joint supports and wound dressing. For the thermoplastic adhesive tapes, once the tape is placed between the two adherends, the joint can sustain the full load without the need for curing, which is an advantage over the thermoset-based adhesives. However, their low toughness renders their application in many structural applications less favorable.

Most of the known adhesive tapes are formed mainly from two components, the adhesive and the carrier or matrix. The choice for the adhesive is very limited. There are three main types of adhesives, rubber, acrylic, and silicon.

The rubber adhesives are mainly used for low stress requirements, such as indoor applications. Acrylic adhesives can be applied for larger stress requirements with long-term bonding. The silicon adhesive is the most expensive one with very good adhesion and high temperature resistant. In terms of the carrier, many materials can act as a carrier such as polyethylene terephthalate (PET), polyethylene (PE), polypropylene (PP), and polyvinyl chloride (PVC), wooden cloth, etc. Most of the available techniques for improving the toughness of the thermoplastic adhesive tapes are based on the change of the matrix material (carrier) that might allow plasticity of the joint during deformation and hence improves the toughness. This technique cannot be applied to medical tapes, where specific adhesive and matrix should be selected to be in contact with human skin.

Thus, there is a need for a new approach for improving the toughness of the thermoplastic adhesive tapes without changing the matrix or the adhesive material.

### SUMMARY OF THE INVENTION

According to an embodiment, there is a double-sided tape that includes a carrier layer having first and second sides opposed to each other, a first adhesive layer located on the first side of the carrier layer, a second adhesive layer located on the second side of the carrier layer, and first defects located between the first side of the carrier layer and the first adhesive layer, or fully within the carrier, or fully within the first adhesive layer. The carrier layer is flexible.

According to another application, there is a method for making a double-sided tape, and the method includes providing a carrier layer having first and second sides opposed to each other over a first roller, providing a first adhesive layer over a second roller, providing a second adhesive layer over a third roller, providing first defects between the first side of the carrier layer and the first adhesive layer, providing second defects between the second side of the carrier layer and the second adhesive layer, and rolling the carrier, the first and second adhesive layers, and the first and second defects into the double-sided tape.

According to yet another embodiment, there is a double-sided tape that includes a first carrier layer, a second carrier layer, a first outer adhesive layer located on one side of the first carrier layer, opposite to the second carrier layer, a second outer adhesive layer located on one side of the second carrier layer, opposite to the first carrier layer, an inner adhesive layer located between the first and second carrier layers, and plural defects located at an interface within the inner adhesive layer. The interface is defined by two adhesive layers that form the inner adhesive layer.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a double-sided thermoplastic adhesive tape having tailored defects at a carrier-adhesive interface;

FIGS. 2A to 2D schematically illustrate a process for making the double-sided thermoplastic adhesive tape of FIG. 1;

FIG. 3 is a flow chart of a method for making the double-sided thermoplastic adhesive tape;

FIG. 4 illustrates a system for making the double-sided thermoplastic adhesive tape;

FIGS. 5A to 5D illustrate the shear stress versus strain relationship for a conventional tape and a double-sided thermoplastic adhesive tape having defects of various sizes;

FIGS. 6A and 6B illustrate a damage sequence in the novel tape;

FIG. 7 illustrates the shear strength and failure initiation strain of a conventional tape and a first novel tape;

FIG. 8 illustrates the shear strength and failure initiation strain of the conventional tape and a second novel tape;

FIG. 9 illustrates a double-sided tape having random defects distributed at the interface between the carrier and one or both adhesive layers;

FIGS. 10A and 10B illustrate the shear stress versus strain experienced by a conventional tape and the tape of FIG. 9;

FIG. 11 illustrates another design of double-sided tape having random defects distributed at the interface between two conventional adhesive tapes;

FIG. 12A shows the force versus displacement experienced by a conventional tape and the tape of FIG. 11 under DCB test configuration;

FIG. 12B illustrates the mode I R-curve for an experimental joint that includes the double-sided tape of FIG. 11; and

FIGS. 13A and 13B illustrate the effect of the toughened thermoplastic adhesive tapes microstructure on mode I and II toughness.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a double-sided tape having defects located between a carrier layer and each of the adhesive layers. However, the embodiments to be discussed next are not limited to double-sides tapes or locating the defects on both sides of the carrier, but may be applied to other tapes and/or applying the defects only to one side of the carrier.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

According to an embodiment, a novel thermoplastic adhesive tape is manufactured with increased toughness and shear fatigue lifetime by modulating the adhesive-carrier interface with tailored defects. The carrier in this embodiment is a flexible material, i.e., it can be bent or folded without breaking as is customary for adhesive tapes. The adhesive material in this embodiment is thermoplastic, i.e., does not need a curing time.

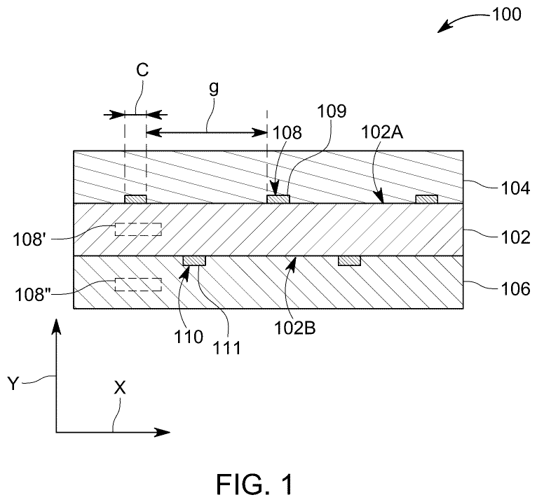

More specifically, as shown in FIG. 1, a double-sided thermoplastic adhesive tape 100 includes a flexible carrier 102 sandwiched between two layers 104, 106 of thermoplastic adhesive material. An example of a thermoplastic adhesive material is polyvinyl acetate (white glue), cyanoacrylate, or hot melts. The term “flexible” is understood herein that the carrier can be folded onto itself with no harm produced to it. Because there is an adhesive layer on each side of the carrier, this tape is called herein a double-sided tape. Different from a traditional double-sided tape, tailored defects 108 are introduced at an interface between the first adhesive layer 104 and the carrier 102. In a variation of this embodiment, it is possible to introduce defects 110 at an interface between the second adhesive layer 106 and the carrier 102. In another variation of this embodiment, it is possible to introduce defects 108, 110 at both interfaces. Note that the first and second adhesive layers 104, 106 are located on opposite sides 102A, 102B of the carrier. In yet another variation of this embodiment, the defects 108 and/or 110 may be located outside the adhesive layers, for example, in the carrier layer 102, as illustrated by reference number 108′, or may be located fully within the adhesive layers 104 and/or 106, as illustrated by reference number 108″. Note that FIG. 1 shows the possible location of the defect 108″ only in the adhesive layer 106 for simplicity, but the defects may also be located in adhesive layer 104. In the following embodiments, the defects are considered to be located between the carrier layer and the adhesive layers for simplicity. However, those skilled in the art should understand that all these embodiments can be modified to have the defects fully within the carrier layer or fully within one or both adhesive layers. The defects 108, 110 may be implemented with a material that has a lower adherence than the adhesive materials of the layers 104 and 106. For example, it is possible to use strips (or a film with strips) of polythetrafluorothylene (PTFE) to create the defects. In one application, the strips 109 of PTFE are placed directly on the carrier 102, have a width c and a gap between two adjacent strips is g, as schematically illustrated in FIG. 1. This means that in this embodiment, the strips 109 are regularly placed along the carrier 102.

The adhesive layer 104 is placed to be in direct contact with the strips 109. The strips 111 may be placed in the same manner as the strips 109, but on the other side of the carrier. In this embodiment, the location of the strips 111 along the longitudinal axis X of the tape 100 is offset relative to the location of the strips 109. For example, it is possible that a location of a strip 111 is midway along the X axis, between two adjacent strips 109. In another application, the strips 111 are randomly placed along the X axis, between two strips 109. However, the strips 109 and 111 are parallel to each other in any of these implementations in this embodiment.

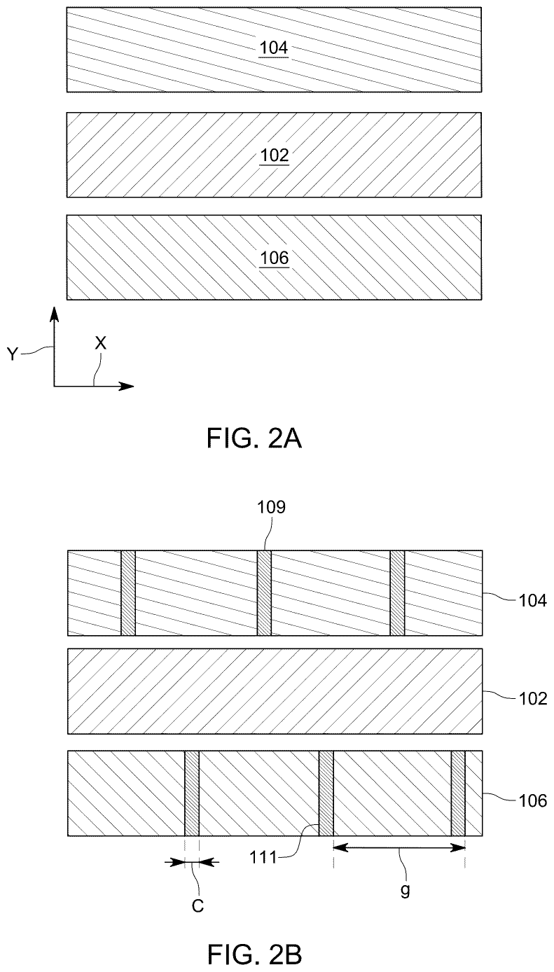

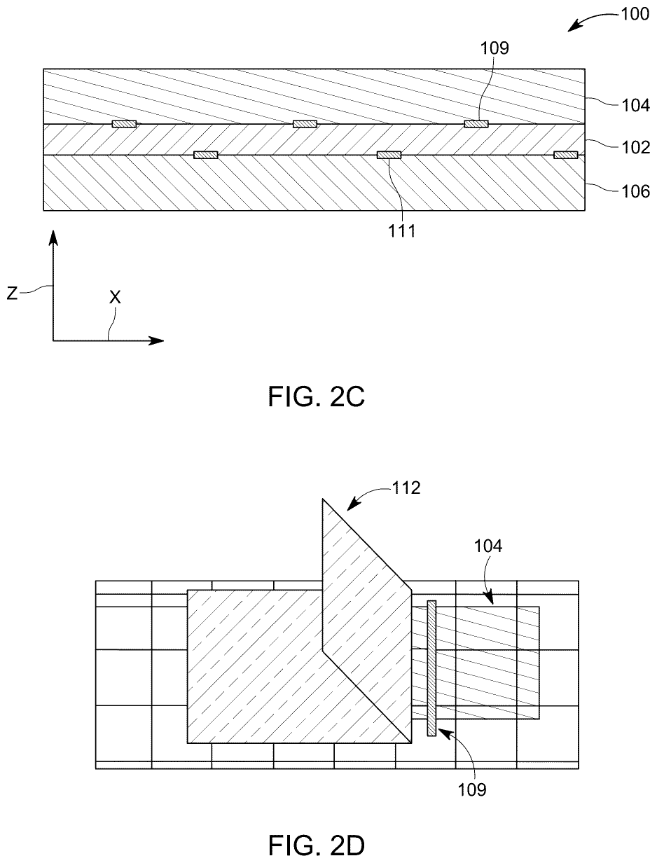

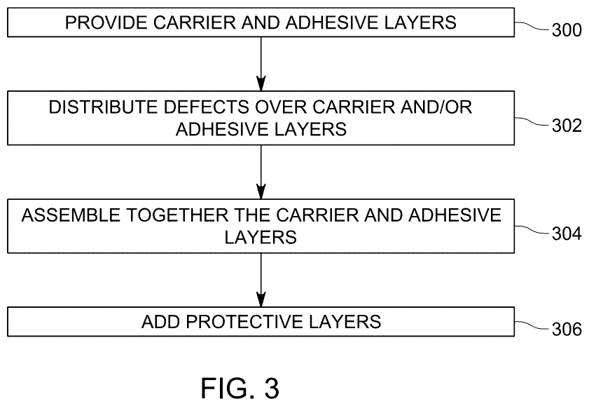

A method for forming the tape 100 is now discussed with regard to FIGS. 2A to 2D and FIG. 3. The method starts with providing the raw materials in step 300, and FIG. 2A shows the starting materials, i.e., the carrier layer 102 and the thermoplastic adhesive layers 104 and 106. Note that no defects are originally present on either of these layers. The carrier layer 102 may be made of any flexible and bendable material. In one application, the carrier layer material may be able to fold onto itself and then return to its original shape with no damage. The adhesive layers 104 and 106 may be made of any thermoplastic adhesive material. In step 302, the defects are added, either to the adhesive layers 104 and 106, as shown in FIG. 2B, or directly to the carrier layer 102. The defects may be strips of the PTFE film as previously discussed, or strips of another material. In one application, the defects are attached to the adhesive layers manually or with a roller. In another application, the defects are sprayed or painted or printed onto the adhesive layers or the carrier layer. Other methods may be used for adding the defects onto the adhesive layers. In yet another variation of this embodiment, it is possible to distribute the defects, by any of the above noted method, directly onto the carrier layer 102 and not onto the adhesive layers.

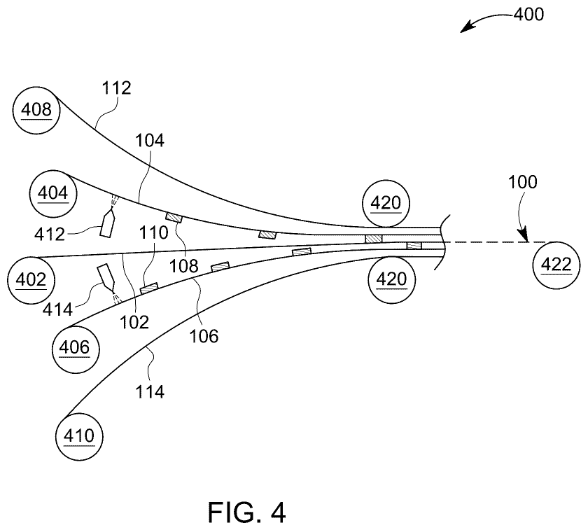

In step 304, the three layers 102 to 106 are rolled together, for example, with the system shown in FIG. 4, to obtain the tape 100 shown in FIG. 2C. In step 306, protective layers 112, 114 (for example, silicon liners) are placed over the adhesive layers to prevent the adherence of the tape to an undesired element.

FIG. 4 shows a manufacturing system 400 that includes a first roller 402 that supports the carrier layer 102, a second roller 404 that supports the first adhesive layer 104, a third roller 406 that supports the second adhesive layer 106, a fourth roller 408 that supports the first protective layer 112, and a fifth roller 410 that supports the second protective layer 114. Nozzles 412 and 414 are shown in this embodiment spraying or printing the defects 108 and 110 on the adhesive layers 104 and 106, respectively. In one application, the nozzles may be replaced by corresponding rollers that support the PTFE defects 108 and 110 and these rollers may provide the defects between the carrier and the adhesive layers. In yet another embodiment, the defects may be already present on the adhesive layers 104 and 106, and thus, nozzles 412 and 414 may be omitted. In still another embodiment, the nozzles 412 and 414 may be replaced with corresponding devices for screen printing, or ink printing or doctor blade application of the defects onto the adhesive or carrier layers. All these layers enter between the pressing rollers 420, which apply a desired pressure to form the double-sided tape 100. The formed tape 100 is then collected by a sixth roller 422.

The inventors have manufactured the tape 100 with different ingredients and tested its characteristics as now discussed. In one application, the adhesive material includes free adhesives called herein Type #1, VAPON Topstic Clear tape, purchased from Vapon tapesR, and Type #2, Lohman Xp-14086 provided by LohmanR. The two types of adhesives have different adhesion abilities and thicknesses. For example, the Type #1 is a low adhesion adhesive with 100 μm thickness, while the Type #2 is a high adhesion adhesive with 20 μm thickness. The carrier material was selected for these tests to be a thin film of Polyethylen terephthalat (PET) having a 50 μm thickness. A tape composed only of a carrier with an adhesive layer over each face was also manufactured for reference purposes and it is referred to herein as a “conventional tape.”

With regard to the tape 100, controlling the parameters c and g would control the ratio of the defect area to the adhesive bonded area, Ad. In a first experiment, the inventors considered two different Ad values, 8 and 16% with two different values of c, 1 and 2 mm. The defect material can be any available material with low adhesion that inhibits the adhesion between the carrier and the adhesive layers at the required position.

The manufactured tape samples were placed over a polyetheretherketone (PEEK) substrate to characterize their adhesion with a typical thermoplastic material that is widely used in medical applications. The tapes were pressed against the PEEK substrate with 1 bar pressure for 20 s and then tested after 10 min. A lap-shear test was conducted to characterize the static and fatigue shear strength of the conventional and advanced adhesive tapes (the tape 100 with the defects discussed above is referred to herein as “an advanced tape”) following ASTM standards, ASTM D5868 and ASTM D3166-99, respectively. The static lap-shear tests were conducted at 1 mm/min loading rate. The fatigue lap-shear tests were performed using the same machine at different percentages of the maximum static load of the joint with a load ratio of 0.5. The fatigue tests were conducted until the maximum load reached half of the initial load, where it was considered that the joint has failed. A digital camera was used to record the damage modes during testing to insitu to recognize the different damage mechanisms in strengthened tapes.

First, the static shear strength and toughness results are discussed.

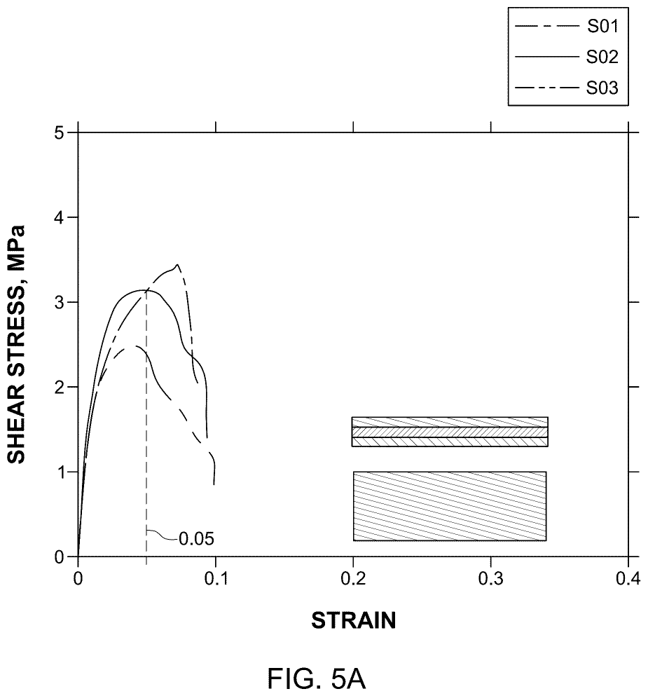

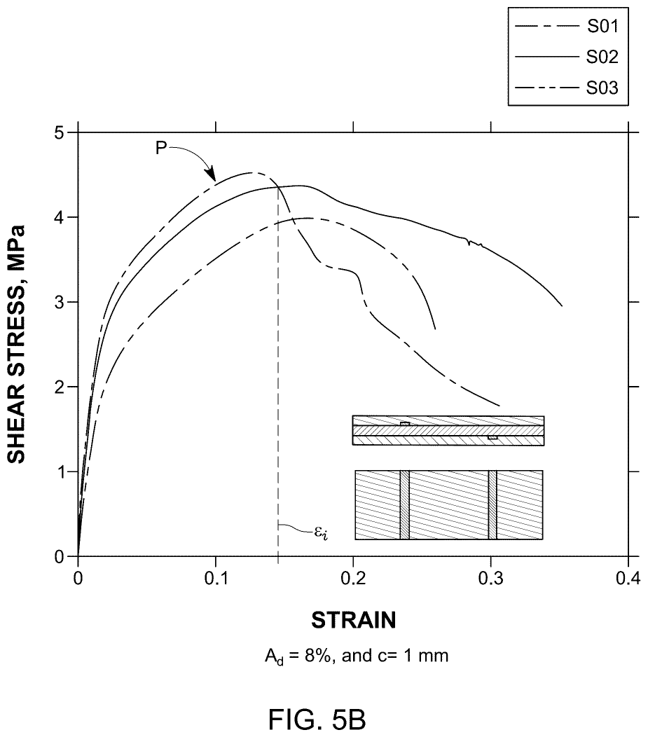

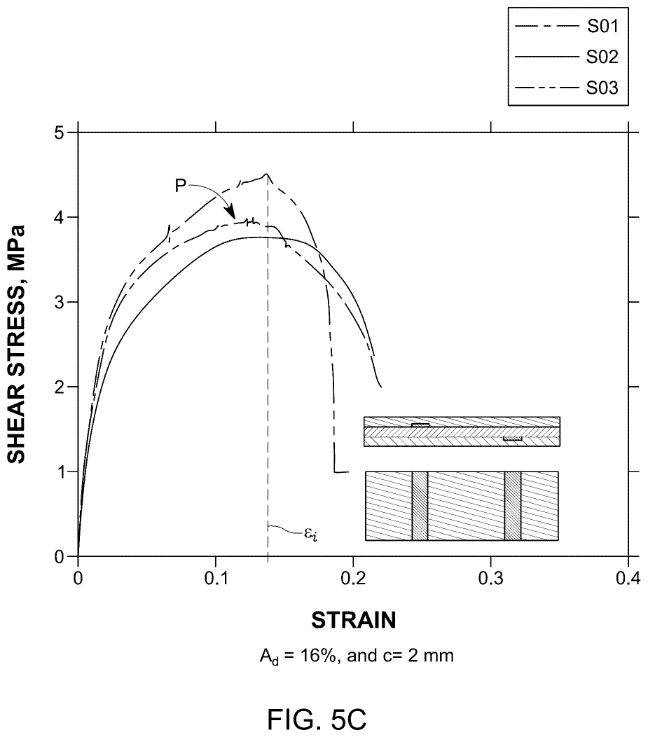

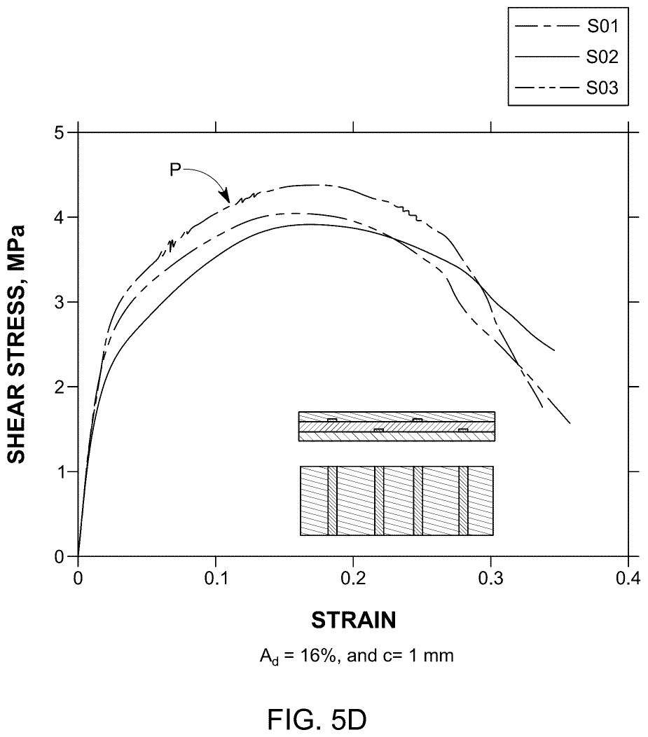

FIGS. 5A to 5D show the stress-strain responses of three samples of type #1 of the conventional and advanced tapes with different defect widths and gaps. The figures show good repeatability of the test for all the selected configurations. For the conventional tape, whose results are illustrated in FIG. 5A, the response is characterized by stress increase with increasing the applied strain until a critical strain around 0.05 is reached, after which a fast reduction of the stress occurs due to the loss of adhesion at the substrate-adhesive interface. However, for the advanced tapes illustrated in FIGS. 5B to 5D, a plateau P was observed when the maximum stress was reached, which indicates that the joint can deform without losing strength until reaching the initiation failure strain, E, after which the strength reduces. All the joints made with the advanced tapes 100 share the same response with some differences in the initiation failure strain and maximum strength.

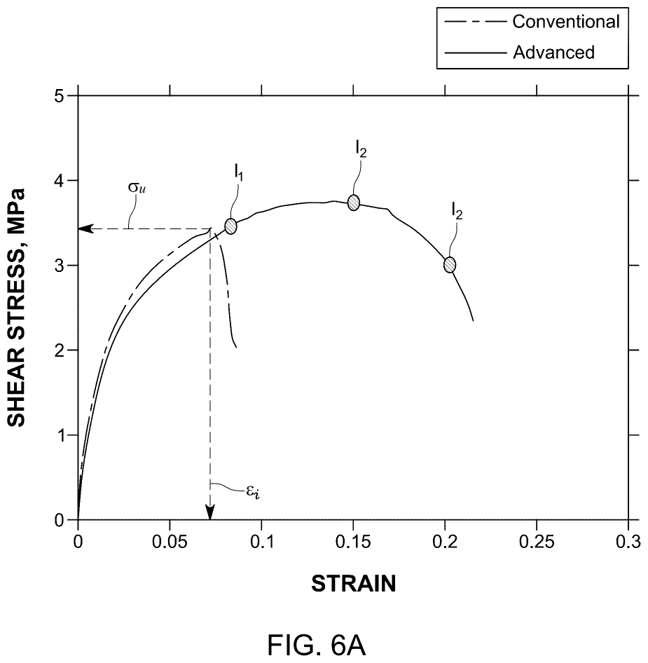

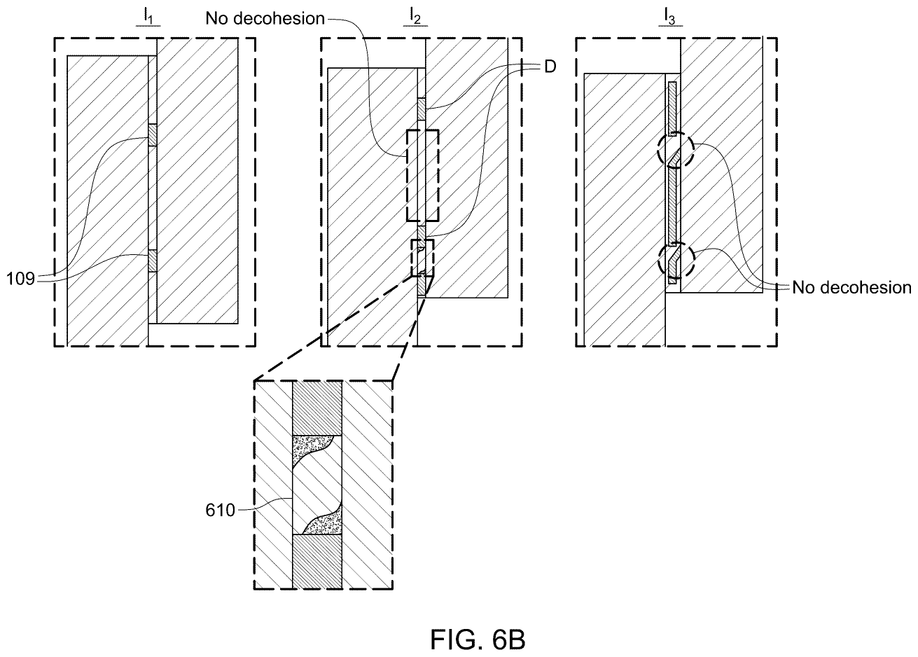

To understand the strengthening and toughening mechanisms, insitu images were taken at different loading stages for the same sample. FIG. 6A shows the stress-strain curve of the conventional and the advanced tape and the damage modes at three different loading levels 11 to 13. Both joints showed similar initial stiffness, where a slight reduction of the stiffness was observed at a stress of 2 MPa due to the local deformation at the defect position. This deformation further increases with increasing the applied displacement as shown in FIG. 6A. The inventors' previous work demonstrated that the existence of such defects inside the bondline, enhances mode I and II fracture toughness of the interface due to the local deformation at the defect position that store part of the applied energy as elastic energy. Therefore, delayed interfacial debonding at the adhesive-carrier interface was observed.

Increasing the displacement, the joint can sustain more stresses due to the release of part of the stresses as local deformation at the defect, until reaching the joint strength, Ou, after which delamination D between the adhesive and the carrier propagate at the end of the bondline, as shown in FIG. 6B. Despite the propagation of the delamination at the adhesive-carrier interface from both ends, the joint can still sustain the maximum shear load as shown in the stress-strain response at “point 12.” Typically, if the delamination grows at the adhesive-carrier interface, reduction in the stress occurs due to the reduction of the contact area that share the load between the two substrates. However, in the advanced tape, the joint can sustain the same stress level even with the propagation of the delamination at the edges of the bondline (see FIG. 6B) due to the formation of adhesive ligaments 610 that deform during loading and share the load capacity with the interfaces. This adhesive layer connects the two substrates and deforms in shear mode that compensates the reduction of the stress due to decohesion at the bondline edges. After “point 12” in the stress strain response in FIG. 6A, the stress reduces due to the propagation of delamination at the area in between the two defects. Even after the reduction of the stress, the two substrates are still connected to each other at the ligament position as shown in FIG. 6B, for point 12. The stress strain response in FIG. 6A highlights two parameters that were used to characterize the tested joints, which are the ultimate strength, Ou, and the failure initiation strain, Ei.

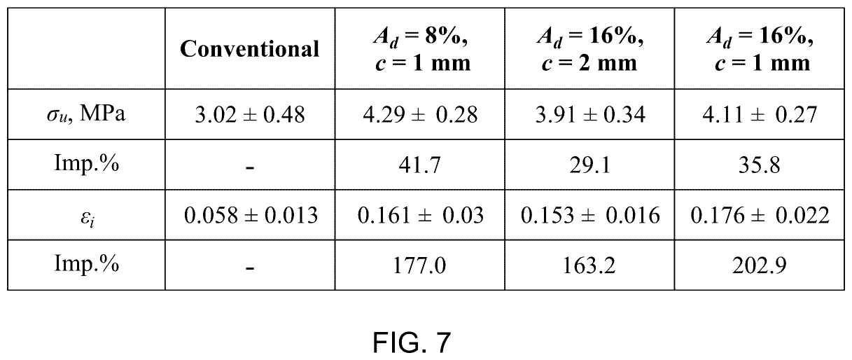

The effect of the defect size c and the ratio of the defect area with respect to the total bond area A_{d} for the type #1 tape is shown in the table in FIG. 7. The advanced tape 100 with A_{d}=8% showed a strength improvement of 41.7%, which is larger than the other two advanced tapes with A_{d}=16%. This is due to the fact that the damage initiation and propagation in the advanced tapes is governed by two main mechanisms as previously explained: the first one is the local deformation at the defect position and the second one is related to the area between the two defects that is fully connected after initiation of delamination at edges. Although the local deformation at the defect position is lower compared to the joint with A_{d}=16%, the connected area between the two defects is larger due to the smaller size of the crack, which resulted in the larger strength of this tape. The failure initiation strain is almost equal for both advanced tapes showing a roughly 170% improvement compared to the conventional tape. Increasing the number of defects by two times, while keeping A_{d} constant, and equal to 16% (c=1 mm) increases the strength improvement rate to 35.8% compared to 29.1% for the tape with c=2 mm due to the dispersion of the stresses at four localization points inside the adhesive tape, which further reduces the stresses at the adhesive-carrier interface and thus increases the shear strength of the tape. Moreover, this tape showed 202.9% improved failure initiation strain compared to 163.2% improvement for the tape with c=2 mm due to the increased deformability of the tape with increasing the number of defects.

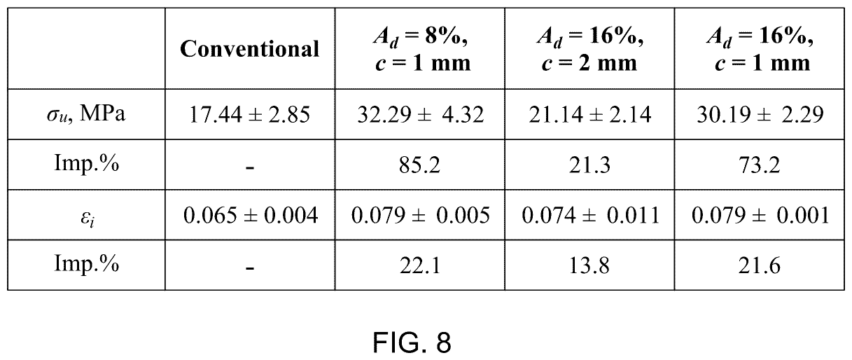

The stress-strain responses (not shown) of the conventional and advanced tapes for Type #2 show a similar trend as for the Type #1 tapes. It was further observed the enhancement in the shear strength and initiation failure strain for the advanced tapes compared to the conventional one. A major difference between Type #1 and Type #2 tapes is that Type #2 tapes have high shear strength, almost 4 times larger than Type #1, and still the strengthening technology works well. However, the improvement in the initiation failure strain is not significant for Type #1 because of the thin adhesive thickness of Type #2, 20 μm, which does not allow for large plastic deformation in the adhesive during deformation. The improvement rates in the shear strength and initiation failure strain for the Type #2 tape are summarized in the table shown in FIG. 8.

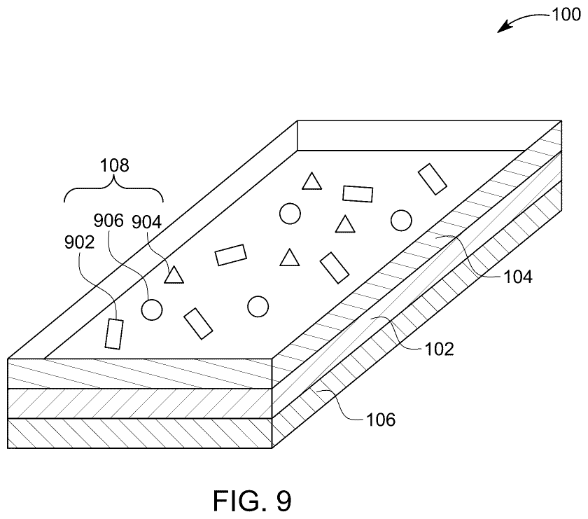

The inventors have found that it might be more practical, for example, from an industrial point of view, to embed random defects at the interface between the carrier layer and the adhesive layers instead of the well-controlled defects 108 and 110. More specifically, FIG. 9 illustrates a modified tape 100 that includes randomly distributed defects 108 at the interface between the carrier layer 102 and the first adhesive layer 104. In this description, the term “random” refers to the location distribution of the defects. However, in one variation of this embodiment, the shape of various random defects 108 may also be random, i.e., the defects 108 may include rectangular 902, triangular 904, and circular 906 defects. The defects 108 may take any shape, regular or irregular. FIG. 9 shows only three regular shapes for simplicity. Also, FIG. 9 does not show, for simplicity, the randomly located and/or randomly shaped defects 110, at the interface between the carrier layer 102 and the second adhesive layer 106. The methods discussed above with regard to FIGS. 3 and 4 may still be used to manufacture this modified strength tape 100.

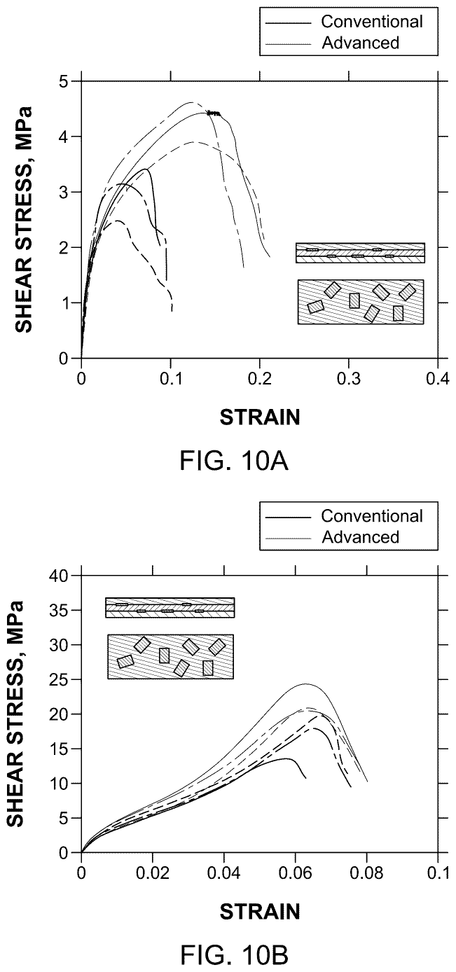

The inventors evaluated the efficiency of embedding random defects on the lap-shear strength and failure strain device for the advanced tapes. FIGS. 10A and 10B show the stress-strain responses of Type #1 and Type #2 conventional and advanced tapes with random defects and a total area fraction A_{d}=16%. For Type #1 material, the advanced tape 100 with random defects showed 4.22 MPa strength and 0.15 initiation failure, as noted in FIG. 10A. Compared to the conventional tape, the advanced tape with random defects showed 39.4% and 158.6% enhancement in strength and initiation failure strain, respectively. Compared to the advanced tape with uniform defects of the same fraction area A_{d}=16%, the tape with random defects showed 8% higher strength and 3% lower initiation failure strain. For the Type #2 tapes, a similar trend was observed in FIG. 10B, where the advanced tape with random defects showed 23.04 MPa strength and 0.068 initiation failure strain, respectively, which demonstrates 32.2 % and 4.9% enhancement in the strength and initiation failure strain compared to the conventional tape. Compared to the advanced tapes with uniform defects with the same fractional area A_{d}=16%, the tape of FIG. 9 showed 9% larger strength and 8% lower initiation failure strain. Thus, globally embedding random defects showed an enhancement in the shear strength compared to the tape with uniform defects. However, the failure strain is reduced, but still much higher than the conventional tapes. The higher strength and lower initiation failure strain of the advanced tape with random defects than the tape with uniform defects was due to the creation of a 3D network of ligaments in the random defects tape, which increases the area of the ligaments that can sustain the load.

Also, the arbitrary shape of the ligaments allows some ligaments to share higher shear stresses than the perfectly aligned ligaments.

The inventors have tested the advanced tapes 100 for fatigue shear strength and toughness. The joint was tested at 70% of the average maximum static load. The tests were performed under displacement control until the maximum load reduces to half of the initial defined load. Thus, the displacement corresponding to 70% of the average maximum static load was calculated and the fatigue cycles run with a displacement ratio of 0.5. The evolution of the load with respect to number of cycles was recorded (not shown) and the test was stopped when the load reaches 40% of the initial defined load. The evolution of the maximum load with respect to the number of cycles, which expresses the stiffness reduction due to fatigue loading, for the Type #1 and Type #2 conventional and advanced tapes was recorded (not shown) and analyzed. Generally, the reduction of the joint stiffness is lower in the advanced tapes than the conventional tape for the two adhesive type tapes. This is due to the presence of defects in the bondline thickness that allows the storing of the applied energy as elastic deformation at the interface between the adhesive and the carrier at the defect positions. Moreover, these defects reduce the stress concentration at the adhesive-substrate interface by creating more local area for stress concentration at the tips of the defect, which reduces the degradation rate of the joint stiffness.

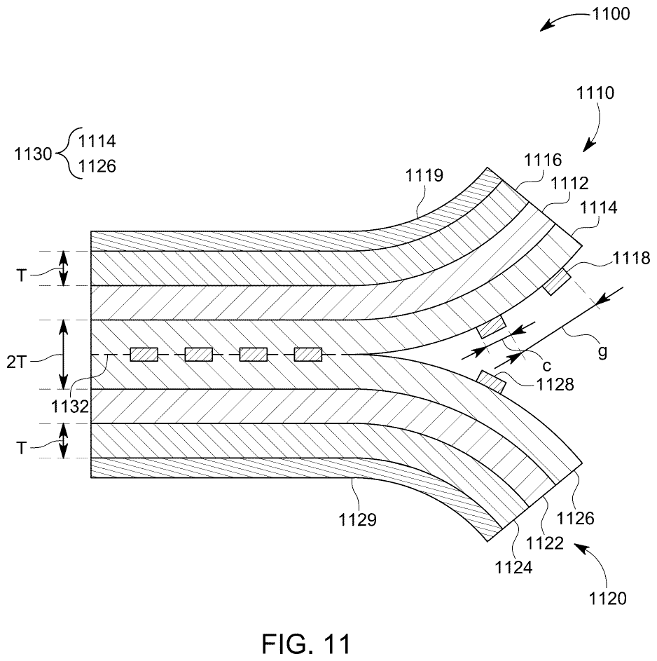

The above embodiments focused on strategically placing adhesive weak regions (or defects) at the interface between the carrier layer 102 and one or both adhesive layers 104 and 106 of a double-sided tape 100. However, the inventors also considered placing the defects between two adhesive layers, as now discussed, to allow local deformation between the adhesive layers and the dispersion of the damage at the adherend-adhesive and adhesive-adhesive interfaces that enhances the toughness of the joint. In this embodiment, toughened thermoplastic tapes 1100 were manufactured using conventional thermoplastic tapes (for example, 3 M high performance double coated tape 9087) of 0.25 mm thickness. The conventional thermoplastic double tape is composed of two adhesive layers placed over the two opposite sides of a carrier. The proposed toughened tape 1100, as shown in FIG. 11, is composed of two subadhesive tapes 1110 and 1120. Each subadhesive tape 1110, 1120 is composed of a carrier 1112, 1122, respectively, and two layers of adhesive 1114, 1116, or 1124, 1126, distributed on each side of the corresponding carrier. The two subadhesive tapes 1110 and 1120 were placed over each other and defects 1118 on the first tape 1110 and/or defects 1128 on the second tape 1120 were tailored at this interface either to be uniformly distributed, as shown in FIG. 11 (and similar to those shown in FIG. 1), or to be randomly distributed, as in FIG. 9. All the characteristics of the defects 108 and 110 previously discussed fully apply to the current defects 1118 and 1128 with the only difference that they are now located between two layers of adhesive 1114 and 1126, from two different tapes, and not at the interface between a carrier layer and an adhesive layer. FIG. 11 also shows cover layers 1119 and 1129 provided over the outer adhesive layers 1116 and 1124, respectively. Because of this specific configuration of the tape 1100, a thickness T of the external adhesive layers 1116 and 1124 is about half the thickness 2T of the resulting inner adhesive layer 1130, which now includes the original adhesive layers 1114 and 1126. In this regard, note that double-sided tape 1100 has two carrier layers 1112 and 1122, one inner adhesive layer 1130, and two external adhesive layers 1116 and 1126, where the inner adhesive layer 1130 is twice in thickness relative to the outer adhesive layers. Because the original adhesive layers 1114 and 1126 were placed together to form the inner adhesive layer 1130, an interface 1132 exists between the two original adhesive layers and the defects 1118 and 1128 are located along this interface. In one variation of this embodiment, it is possible to add the defects 108 and 110 from the tape 100 shown in FIG. 1, to the tape 1100 shown in FIG. 11, so that the tape 1100 has defects not only at the interface 1132, but also at the interface between the carrier layers and the corresponding adhesive layers. In one variation, the elements 1114, 1118, 1128, and 1126 that form the inner adhesive layer 1130 are produced as a single layer of any adhesive/thermoplastic material and this single layer 1130 is then inserted between two carriers 1112 and 1222.

In one application, a PTFE film of 18 μm thickness with a predefined width may be used to generate the defects 1118 or 1128. Thus, the manufacturing of the toughened tape 1100 may be performed according to the following steps. In a first step, one of the covers (note that each of the original tapes 1110 and 1120 comes with two cover layers, one on each of the adhesive layer) of the first tape was removed. Then, in the second step, the PTFE film with the designed width c, and gap between films, g, was placed over the exposed adhesive layer of the first tape 1110. The same first and second steps may be repeated for the second tape 1120. The distance, along the longitudinal axis, between the slits of two successive PTFE films (one for the first tape and one for the second tape) over each of the conventional tapes equals 2 g+c. After placing the PTFE film, the two tapes were pressed during a third step against each other with an offset between the defects on the adhesive bondline. This offset may be generated to be uniform (i.e., the defect 1128 falls in the middle of the distance between two adjacent defects 1118) or non-uniform.

To characterize the toughened tape 1100, a sample was manufactured by applying the low adhesion material (PTFE) film 1118 with 18 μm thickness over the first tape and the film 1128, with the same thickness, over the second tape. Note that only one of the films may be used for achieving the tape 1100. Also note that the strips or defects 1118 may be part of a film that is placed over the first tape, and for this reason, the terms strip, defect and film 1118 are used interchangeably herein.

After adding these PTFE films, the other tape has been added to the first tape to be ready for application inside the joint. The PTFE film was cut to 4 mm width strips using a cutting plotter, and the PTFE film was placed over the first layer of the tape with 5 mm gap between the two successive strips. Unidirectional carbon fiber prepregs composed of epoxy resin and carbon fibers were used to manufacture adherends to quantify the mode I toughness of the manufactured toughened tapes. The nominal ply thickness was 250 μm and the fiber volume fraction was 57%. The adherents were manufactured using hand lay-up of 8 plies with 0-direction over a commercial polyamide sheet, resulting in an adherend of 2 mm nominal thickness.

The stacked plies were cured by compression molding process using hydraulic hot pressing machine at 180° C. temperature and 7 bar pressure and held for 2 h duel time. The heating and cooling rates were kept constant at 3° C./min.

The Double Cantilever Beam (DCB) test was performed following the ASTM D5528-13 standard to characterize the mode I toughness of the manufactured joint. The sample width was 20 mm while the length was 150 mm with a 50 mm initial crack. Aluminum blocks were bonded to the DCB samples using epoxy to be used for load application. The test was performed using a mechanical testing machine under displacement control of 1 mm/min rate. A high-resolution camera was used to capture the insitu damage modes. The fracture toughness was calculated using the closed-form solution known in the art.

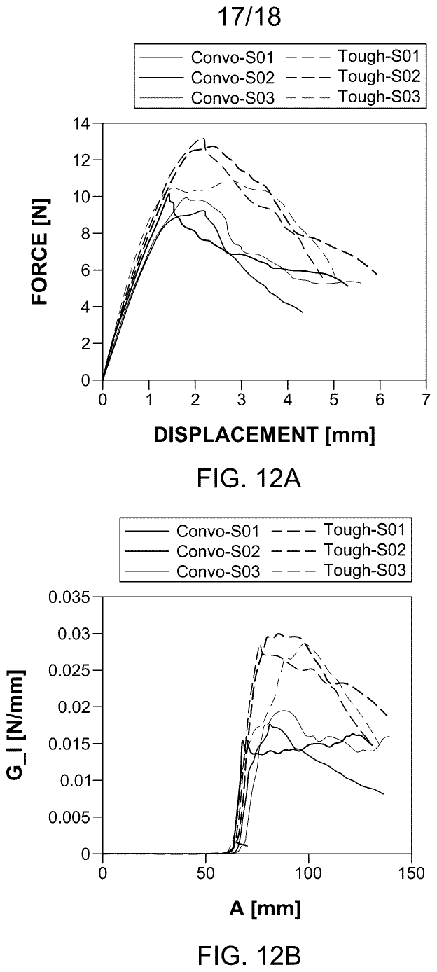

Tape 1100 was tested along a conventional tape for thermoplastic adhesive joints under DCB and the R-curve of the joints was evaluated. Both the conventional and toughened tapes have the same structure with the same number of layers with a single difference, which is the embedding of sacrificial defects 11118/1128 of 4 mm width and a gap between two successive defects of 5 mm. FIG. 12A shows the load-displacement response of the conventional and toughened adhesive tape. The load of the toughened adhesive tape is larger than the load of the conventional tape. Moreover, the mode I toughness of the toughened tape is 0.027 N/mm compared to 0.015 N/mm for the conventional tape, achieving 80% toughness improvement (see FIG. 12B). The toughness improvement is attributed to the difference in the damage modes, where larger sources of energy dissipation are presented in the toughened tapes than the conventional one. In the conventional tapes, the damage initiates at the lower interface between the tape and the lower adherend and propagates at the same interface. However, for the toughened tape 1100, the damage initiates at the interface between the tape and the upper adherend. When the crack reaches the first sacrificial defect, the crack at the upper interface is arrested and a new crack appears at the adhesive/adhesive interface.

After that, a third crack initiates at the lower interface, between the tape and the lower adherend, which leads to the formation of two adhesive ligaments. These adhesive ligaments dissipate a larger energy due to their high plasticity. The same damage mode is repeated at the second sacrificial defect, where the crack propagates between the upper adherend and the tape interface and at the adhesive/adhesive interface. These three damage mechanisms, the crack migration, the crack propagation at the adhesive/adhesive interface and the plastic deformation of the adhesive ligaments results in the dissipation of a larger energy then the conventional tape, which improves the toughness of the joint.

The effect of the defect size c and the gap between successive defects g on the load-displacement and the R-curve of DCB joints made of the toughened thermoplastic tape 1100 were also studied. A global difference between the conventional and toughed adhesives is the presence of the several load and toughness drops in the load-displacement and the R-curve of the toughed tapes; however, the response is smooth for the conventional joints. The smooth response of the conventional adhesive is a typical response, where once the strain energy reaches the critical fracture toughness of the interface, a crack propagates at this interface following the linear elastic fracture mechanics theory. However, for the toughened adhesives, the load and toughness drops indicate crack propagation arrest/jump during propagation. The DCB response of the toughness tapes was influenced by the defect size and the gap between two defects. The crack length has an insignificant effect on the critical fracture toughness of the tape, however, it affects the total energy stored in the tape. The gap between cracks seems to have no significant effect on the fracture toughness except, for the case of a large gap of 5 mm, a smaller toughness improvement is achieved.

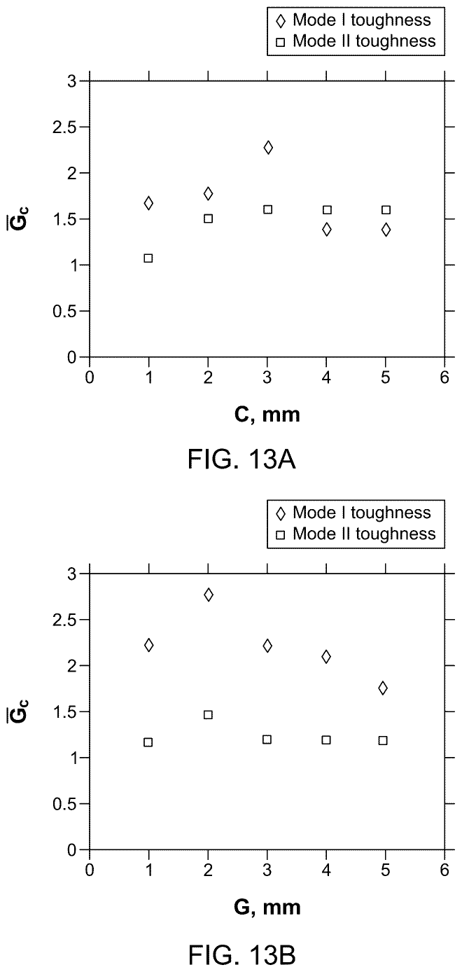

The effect of the toughened thermoplastic adhesive microstructure on the mode I and II toughness of the tape 1100 is illustrated in FIGS. 13A and 13B. In these figures, the term G. represents the normalized toughness of the toughened tape with respect to the conventional tape. Both the defect size c and the gap g between two successive defects influence the mode I and II toughness improvement. Increasing the defect size c improves the mode I and II toughness up to a certain limit. For the tape with g=5 mm, the maximum mode I and II toughness improvement was achieved for a defect size of 3 mm, where the mode I and II toughness were 2.27 and 1.6 times larger than the conventional tape. Further increasing the defect size c reduced the improvement of mode I toughness and stabilized the improvement rate in mode II toughness. For the tape with a 2 mm defect size c, the maximum mode I and II toughness improvement was achieved for a gap g of 2 mm, where the mode I and II toughness were 2.78 and 1.47 times larger than the conventional tape.

From an industrial point of view, the development of these toughened tapes is viable because it can be produced following the same manufacturing process as the conventional tape by just adding an extra step of embedding the PTFE film (defects) between the two adhesive layers 1114 and 1126. From an economical point of view, the proposed toughening strategy is economically efficient because even if the amount of adhesive and matrix is doubled for the final tape, it achieves more than double toughness improvement.

The disclosed embodiments provide an enhanced toughness double-sided thermoplastic tape that is capable of joining together various materials. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.

WIPO International Publication Number WO 2021/260502.

1. A double-sided tape comprising:
a carrier layer having first and second sides opposed to each other;
a first adhesive layer located on the first side of the carrier layer;
a second adhesive layer located on the second side of the carrier layer; and
first defects located between the first side of the carrier layer and the first adhesive layer, or fully within the carrier, or fully within the first adhesive layer,
wherein the carrier layer flexible.

2. The double-sided tape of claim 1, further comprising:
second defects located between the second side of the carrier layer and the second adhesive layer, or fully within the second adhesive layer,
wherein the first and second defects are made of a material that has less adhesive properties than the first and second adhesive layers.

3. The double-sided tape of claim 2, wherein the first defects are interleaved with the second defects.

4. The double-side tape of claim 2, wherein each of the first and second defects has a width c that is constant along the tape, and a gap g between two adjacent first defects or two adjacent second defects is constant.

5. The double-side tape of claim 4, wherein each second defect is placed at a middle position in the gap g of two first defects, along a longitudinal axis of the tape.

6. The double-side tape of claim 1, wherein the first and second defects are outside the first and second adhesive layers.

7. The double-side tape of claim 1, wherein the first and second defects are shaped as rectangles.

8. The double-side tape of claim 1, wherein the first and second defects are randomly distributed along the carrier layer.

9. The double-side tape of claim 8, wherein the first and second defects are randomly shaped.

10. The double-side tape of claim 1, wherein the first and second defects are randomly shaped.

11. The double-side tape of claim 1, wherein the first and second adhesive layers include a thermoplastic material.

12. A method for making a double-sided tape, the method comprising:
providing a carrier layer having first and second sides opposed to each other over a first roller;
providing a first adhesive layer over a second roller;
providing a second adhesive layer over a third roller;
providing first defects between the first side of the carrier layer and the first adhesive layer
providing second defects between the second side of the carrier layer and the second adhesive layer; and
rolling the carrier, the first and second adhesive layers, and the first and second defects into the double-sided tape.

13. The method of claim 12, wherein the step of providing first defects comprises:
spraying the first defects onto the carrier layer or onto the first adhesive layer.

14. The method of claim 12, wherein the step of providing first defects comprises:
providing a film with slits between the carrier layer and the first adhesive layer.

15. The method of claim 12, wherein the step of providing first defects comprises:
printing the first defects over the carrier layer or the first adhesive layer.

16. The method of claim 12, wherein the first and second defects are made of a material that has less adhesive properties than the first and second adhesive layers and the first defects are interleaved with the second defects.

17. The method of claim 12, wherein each of the first and second defects has a width c that is constant along the tape, and a gap g between two adjacent first defects or two adjacent second defects is constant.

18. The method of claim 12, wherein the first and second defects are outside the first and second adhesive layers.

19. A double-sided tape comprising:
a first carrier layer; a second carrier layer;
a first outer adhesive layer located on one side of the first carrier layer opposite to the second carrier layer;
a second outer adhesive layer located on one side of the second carrier layer opposite to the first carrier layer;
an inner adhesive layer located between the first and second carrier layers; and
plural defects located at an interface within the inner adhesive layer,
wherein the interface is defined by two adhesive layers that form the inner adhesive layer.

20. The tape of claim 19, wherein a thickness of the inner adhesive layer is larger than a thickness of each of the first and second outer adhesive layers.
